(19) United States
(12) Patent Application Publication
(10) Pub. No.: US 2002/0147741 A1
(43) Pub. Date: Oct. 10, 2002

(54) Data processing apparatus for accessing web page data and method for accessing and processing web page data

(75) Inventor: Tatsuya Hashimoto, Tokyo (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/114,467

(22) Filed: Apr. 3, 2002

(30) Foreign Application Priority Data
Apr. 4, 2001 (JP) P2001-105956

(51) Int. Cl. G06F 15/00

(52) U.S. Cl. 707/500

(57) ABSTRACT

Methods and apparatuses are provided to facilitate using URL data with a hand-held data processing apparatus which is coupled to a communication network. Provided methods include selecting a desired URL data using a selection button when a web page is displayed, and registering the URL data for the displayed web page and URL data corresponding to one or more link points in the web page.

### CROSS-REFERENCE TO RELATED APPLICATIONS

This application claims the benefit of priority from Japanese Patent Application No. 2001-105956, filed on Apr. 4, 2001, the disclosure of which is expressly incorporated herein by reference in its entirety.

### BACKGROUND OF THE INVENTION

1. Field of the Invention

The invention relates to accessing data using a communication network. More particularly, the present invention relates to recording and/or reproducing information for accessing a resource using a communication network such as, for example, a uniform resource locator (URL) identifying a web page which may be accessed using a hand-held data processing apparatus.

2. Description of the Related Art

Recent wide spread use of personal computers (PC) and hand-held data processing apparatuses such as, for example, personal digital assistants (PDA) and mobile telephones have led to a rise in the number of users who desire to access scattered web page data on networks, such as the Internet. In general, various kinds of web browser software corresponding to each communication system may be used to search and/or access data on each network. For example, Internet software such as INTERNET EXPLORER™ software manufactured by MICROSOFT™ Corporation may be used in order to search for data on the Internet and/or access data through the Internet, such as data on world wide web (WWW) sites.

When perusing web sites using web browser software, a user may store a URL of a particular web page in a memory to repeatedly access that web page. For example, with INTERNET EXPLORER™ the user may store URL information corresponding to a particular web page by using a “favorite” function when that web page is displayed on a screen of a data processing apparatus, such as a personal computer.

Moreover, when a web page includes particular URL information such as, for example, a data link, the particular URL information may be stored by positioning a pointing cursor on a character sequence indicating the URL information and clicking a mouse button for a data processing device. For example, in case of a hypertext markup language (HTML), a tag for specifying a link may be indicated and the “head” of the tag may describe an address of a link point. Then the character sequence identified by the tag may be registered as an anchor. In the web browser, a character sequence of the anchor may be displayed by attaching a colored underline. Accordingly, the URL information for the link point may be stored by clicking a right button in a mouse device when a cursor is positioned on the underlined character sequence.

Japanese Application Publication 11-265397, published Sep. 28, 1999, discloses a technique for displaying a web page based on particular URL information that is stored by pasting the URL information into a scrap book. The pasted URL information contains data regarding a link point described in the web page. A user may display the web page by indicating the memorized URL information in the scrap book.

Such techniques may be applicable to a data processing apparatus having a relatively large-sized display screen, such as a personal computer (PC). However, in comparison to PCs, a hand-held data processing apparatus such as, for example, a PDA or a mobile telephone usually include a small-sized data display screen. Moreover, a hand-held data processing apparatus typically employs a selection button or an input pen in order to select data. Thus, the selection button or the pen is used for inputting data. Consequently, various kinds of operations are required in order to access data though the Internet on a small-sized display screen.

Moreover, a PC and a hand-held data processing apparatus may respectively employ different kinds of operating systems (OS). Differences between the OS corresponding to a PC and the OS corresponding to a hand-held data processing apparatus may prevent directly applying the above-mentioned techniques to repeatedly used web page data since the data processing apparatus has a relatively small sized display screen. Thus, it is impossible for the hand-held data processing apparatus with a small-sized display screen to apply the same techniques as used for the PCs.

### SUMMARY OF THE INVENTION

Accordingly, the present invention provides apparatuses and methods for easily reusing URL information of a particular web page on a small-sized screen in a handheld data processing apparatus.

The present invention also provides apparatuses and methods for easily designating URL information in a hand-held data processing apparatus.

The present invention further provides apparatuses and methods for easily registering URL information for a displayed web page and URL information for a link point indicated in the displayed web page.

A data processing apparatus consistent with the present invention may include a communication controller for performing communication on a network; a web page data memory for storing downloaded web page data on the network through the communication controller; a web page display for displaying web pages based on the web page data stored in the web page data memory; an indicator for indicating a specified portion on the web page displayed on the web display; and an address data memory for storing address data included in the web page data.

Another data processing apparatus consistent with the present invention may include a web page data memory for storing web pages; a web page display for displaying a web page based on web page data stored in the web page data memory; a selector for selecting a specified portion of the web page displayed on the web display; and an address data memory for storing address data included in the web page data in accordance with the specified portion.

Yet another data processing apparatus consistent with the present invention may include a web page data memory for storing web pages; a web page display screen for displaying a web page based on web page data stored in the web page data memory; a cursor button for pointing a cursor on the web page display screen, the cursor is displayed at least per line on the display screen; a registration instructing button for instructing registration of address data included in the displayed web page; a unit for acquiring address data included in the web page data at a position pointed by the cursor button, during when the registration instructing button is operated; and an address data memory for storing the acquired address data.

Still another data processing apparatus consistent with the present invention may comprise a communication controller configured to communicate using a network; a web page data memory configured to store web page data downloaded from the network using the communication controller; a web page display configured to display at least one web page based on the web page data stored in the web page data memory; an indicator configured to specify an indicated portion of the web page displayed on the web page display; and an address data memory configured to store address data associated with the web page data.

Yet another data processing apparatus consistent with the present invention may comprise a web page data memory for storing web pages; a web page display for displaying a web page based on web page data stored in the web page data memory; a selector configured to select a specified portion on the web page displayed on the web display; and an address data memory configured to store address data included in the web page data in accordance with the specified portion.

Still another data processing apparatus consistent with the present invention may comprise a web page data memory configured to store web pages; a web page display screen configured to display a web page based on web page data stored in the web page data memory; a cursor button configured to move a line cursor displayed on the display screen; a registration instructing button configured to register address data included in the displayed web page; a unit configured to acquire address data associated with the web page data at a position pointed by the cursor button, when the registration instructing button is operated; and an address data memory configured to store the acquired address data.

A method for processing data consistent with the present invention may include downloading data of a web page on a network over a radio communication link; storing the downloaded web page data into a web page data memory; displaying the web page based on the stored web page data in the web page data memory; indicating a specified portion on the web page displayed on the display web page; and storing address data included in the indicated specified portion of the web page as a registration data.

A computer program product consistent with the present invention may comprise a computer readable medium having computer program code embodied in said medium, wherein said program code comprises code for controlling communication using a network; code for storing web page data downloaded from the network in a web page memory; code for displaying a web page according to the web page data stored in the web page memory; code for specifying an indicated portion of the web page displayed on the web page display; and code for storing address data associated with the web page data in an address memory.

Additional aspects of the invention will be set forth in part in the description which follows, and in part will be obvious from the description, or may be learned by practice of the invention. Features and advantages of the invention will be realized and attained by means of the elements and combinations particularly pointed out in the appended claims. It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate several embodiments of the invention and together with the description, serve to explain the principles of the invention. A more complete appreciation of the present invention and its many attendant advantages thereof may be readily obtained and better understood by reference to the following detailed description when considered in connection with the accompanying drawings, wherein:

FIG. 1 shows an exemplary hand-held data processing apparatus in accordance with methods and systems consistent with the present invention;

FIG. 2 is a block diagram of an exemplary system for recording and reproducing URL data using the hand-held data processing apparatus of FIG. 1 in accordance with methods and systems consistent with the present invention;

FIG. 3 is an exemplary flowchart showing a URL data registering operation in accordance with methods and systems consistent with the present invention;

FIG. 4 is an exemplary flowchart showing a routine for displaying a web page in accordance with methods and systems consistent with the present invention;

FIG. 5 shows an exemplary web page which may be displayed on an LCD screen of a display/input unit consistent with the system of FIG. 2 in accordance with methods and systems consistent with the present invention;

FIG. 6 illustrates an exemplary state where an active cursor is moved on a specified line of the web page of FIG. 5, in which the active cursor may be moved up and down on the web page displayed on an LCD screen by operating the data processing apparatus shown in FIG. 1, in accordance with methods and systems consistent with the present invention;

FIG. 7 illustrates an exemplary state where a sub-menu is displayed on the web page of FIG. 5, in which the active cursor is used to select displayed link data in accordance with methods and systems consistent with the present invention;

FIG. 8 illustrates an exemplary state where the sub-menu of FIG. 7 on the web display screen may be opened using a function button via the data processing apparatus of FIG. 1 when no link data has been designated in accordance with methods and systems consistent with the present invention;

FIG. 9 illustrates exemplary memory contents stored in a URL data memory in accordance with methods and systems consistent with the present invention;

FIG. 10 illustrates exemplary source data for displaying the web page of FIG. 5 in accordance with methods and systems consistent with the present invention;

FIG. 11 illustrates an exemplary state in which a simple registration URL menu may be displayed on a web page in accordance with methods and systems consistent with the present invention;

FIG. 12 illustrates an exemplary state in which an input gesture may be used to register a URL in accordance with methods and systems consistent with the present invention;

FIG. 13 illustrates another exemplary data processing apparatus which may be configured in a cellular telephone in accordance with methods and systems consistent with the present invention;

FIG. 14 illustrates another exemplary data processing apparatus in which content may be displayed in a web page using the mobile telephone of FIG. 13 in accordance with methods and systems consistent with the present invention;

FIG. 15 illustrates an exemplary state of the web page of FIG. 14 in which a specific portion of content in the web page may be selected in accordance with methods and systems consistent with the present invention.

### DETAILED DESCRIPTION

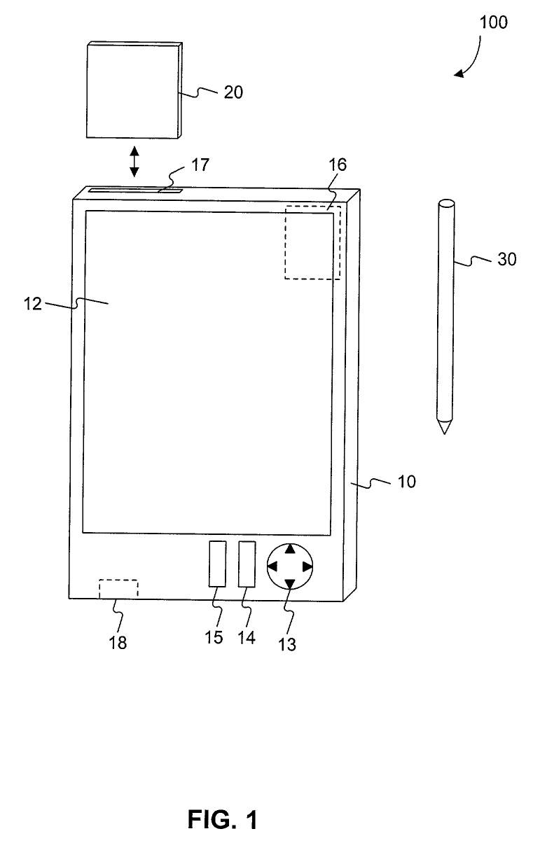

FIG. 1 shows an exemplary hand-held data processing apparatus 100 in accordance with methods and apparatus consistent with the invention. The data processing apparatus 100 comprises, for example, a main body 10, a memory medium 20, and a pen member or stylus 30.

The main body 10 may include, for example, a display/input unit 12, a selection button 13, a first function button 14, a second function button 15, a communication module 16, an interface unit 17, and an external power supply plug unit 18. The display/input unit 12 may include, for example, a liquid crystal display (LCD) for displaying various data and a tablet unit for inputting data. The selection button 13 may be used to select data and to move a cursor. The first function button 14 may be used to set up a URL registration function. The second function 15 may be used to set up another function.

The memory medium 20 may store URL data and web page data. The pen member 30 may be used to input data using the display/input unit 12. The communication module 16 may be used for wireless communication such as, for example, radio communication using a BLUETOOTH™ protocol. The interface unit 17 may be used to couple the memory medium 20 to the main body 10.

In this exemplary hand-held data processing apparatus, a tablet unit in the display/input unit 12 may determine position coordinate data using a pressure sensitive system to detect input from the pen 30. In an alternative embodiment the tablet unit may detect input from the input pen 30 using an electrical capacitance system.

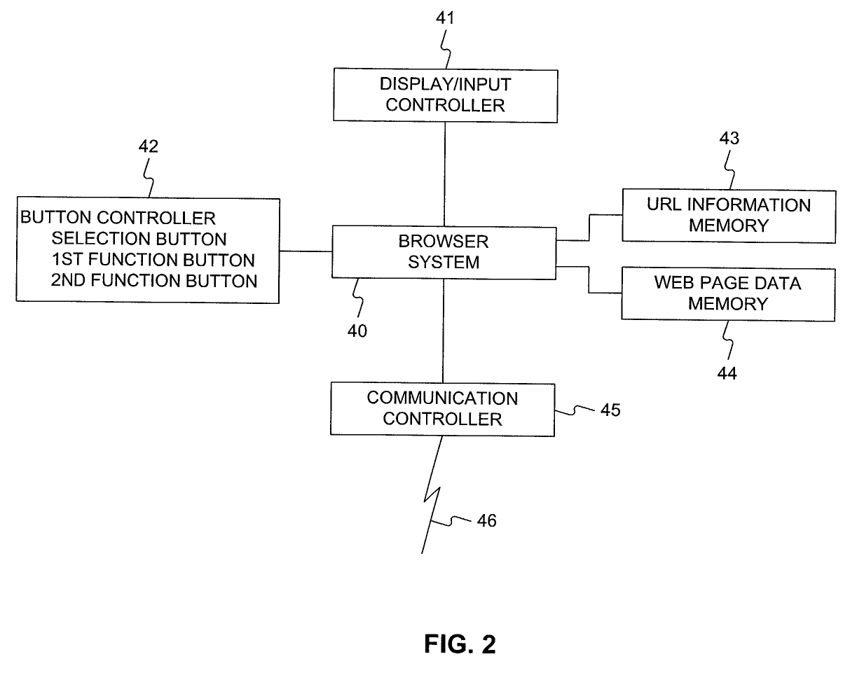

FIG. 2 is a block diagram of an exemplary system for recording and reproducing URL data (information) using the data processing apparatus of FIG. 1 in accordance with methods and systems consistent with the present invention. Data processing apparatus 100 (shown in FIG. 1) may include, for example, a browser system 40, a display/input controller 41, a button controller 42, a URL data (information) memory 43, a web page data memory 44, and a communication controller 45.

The browser system 40 may be used to control the operations of browsing web data. The display/input controller 41 may perform input or output operations of data on the display/input unit 12. For example, button controller 42 may supply actual control data in accordance with a selection signal supplied from selection button 13, or an easy URL registration signal supplied from first function button 14 or second function button 15. The URL data memory 43 may store URL data that is specified to be registered by a user. The web page data memory 44 may store source data for the web page. The communication controller 45 may control input/output operations of data acquired through a wireless communication interface 46 such as, for example, a Bluetooth radio communication interface.

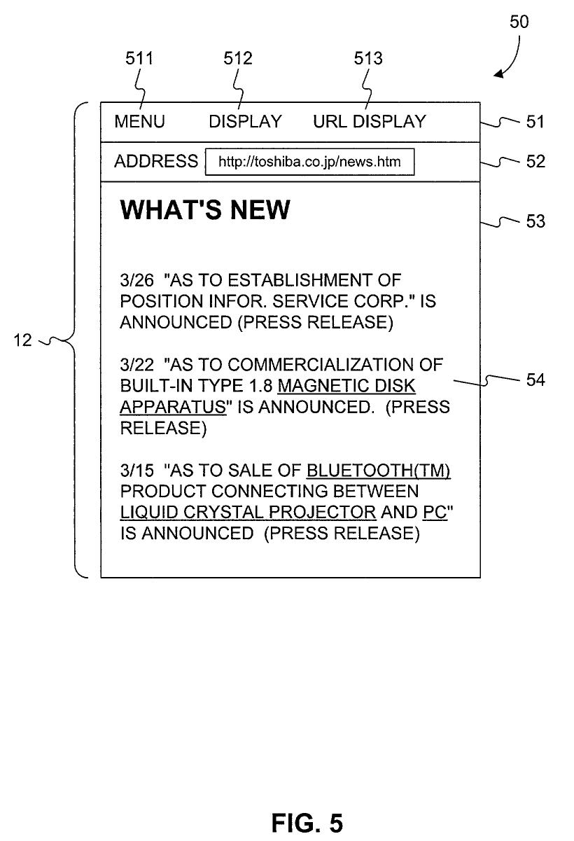

FIG. 5 shows an exemplary web page which may be displayed on an LCD screen of a display/input unit consistent with the system of FIG. 2 in accordance with methods and systems consistent with the present invention. Practical operations for registering the URL information will be explained by reference to the exemplary web page which may be displayed on the LCD screen 12 of data processing apparatus 100 (shown in FIG. 1). Using browser software in the browser system 40, the communication controller 45 may access the web page through the wireless communication interface 46 and may generate a display on the LCD screen at an initial stage such as, for example, the exemplary web page illustrated in FIG. 5.

As illustrated in FIG. 5, a web page 50 displayed on the screen 12 may include a menu area 51, an address area 52, and a page area 53. The menu area 51 may display various kinds of menus, such as a Menu 511, a Display 512, and a URL Display 513. The address area 52 may display URL data for the displayed web page 50. The page area 53 may display contents of the web page 50. The web page data may include underlined portions 54 and 55 as link data. The link data may indicate one or more other web pages which are linked to the displayed web page 50. Thus, by clicking the respective linked portions, the web page screen may be changed to another linked web page by automatically switching to the URL for another web page.

Thus, browser system 40 (shown in FIG. 2) may be used to download source data for a web page from a position indicated by a particular URL and may store the source data for the web page in the web page data memory 44. In accordance with the downloaded source data, the browser system 40 may display a particular address for the web page in the address display area 52. Further, data based on the source data may be displayed in the page area 53. In this case, if the character data consists of a single line in HTML and cannot be displayed in one line, a display line may be suitably split or truncated for display in accordance with the size of the page area 53. As explained above, the underlined portions 54 and 55 may indicate a corresponding URL linked to another web page. In the example shown in FIG. 5, the link point may be established by underlining of a character sequence. Of course, in an alternative embodiment the link point may be established using image data such as, for example, icons, symbols, or graphics.

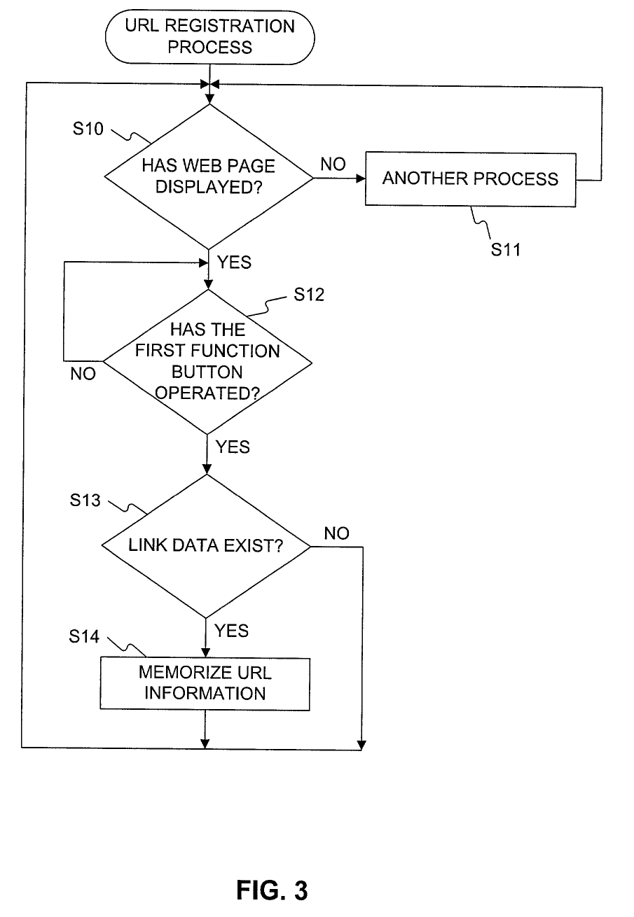

FIG. 3 is an exemplary flowchart showing a URL data registering operation in accordance with methods and systems consistent with the present invention. First, the browser system 40 (shown in FIG. 2) in the data processing apparatus 100 (shown in FIG. 1) may determine whether a web page has been displayed on the display/input unit 12 (step S10). If it determines that a web page has not yet been displayed on the display/input unit 12 (step S10, NO), then the browser system 40 may perform other tasks (step S11). If the browser system 40 determines that a web page has been displayed on the display/input unit 12 (step S10, YES), then the process may proceed to step S12 to determine whether the first function button 14 for setting up an easy URL registration function is operated when the web page is displayed (step S12). If the first function button 14 has not operated (step S12, NO), the process may loop repeatedly without altering the displayed web page data. However, if the first function button 14 has been operated when the web page is displayed (step S12, YES), then the process may determine whether the presently displayed web page includes any linked data associated with the URL link information at a position indicated by an active cursor (step S13). If no associated link data exists (step S13, NO), then the process may return to step S10. If any associated link data is confirmed at the position indicated by the active cursor (step S13, YES), then both the presently displayed URL data and the linked URL data may be stored in URL data memory 43 along with registration time information (step S14).

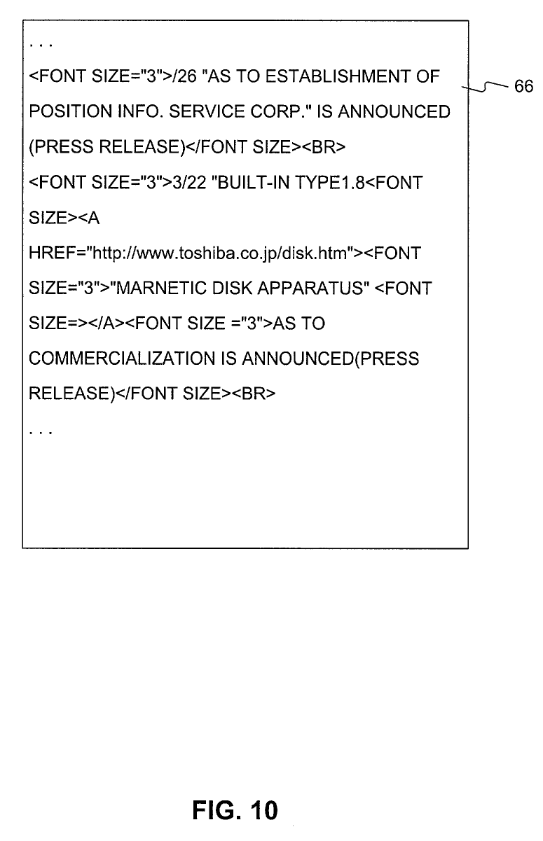

The source data for the web page may include data described by a language such as, for example, a hypertext language such as HTML. FIG. 10 illustrates an example of the source data 66 for a web page 50. Thus, based on the source data stored in the web page data memory 44, the browser system 40 can distinguish whether link data is setup at a particular position in a displayed screen by moving an active cursor up and down by using the selection button 13. Thus, based on the source data stored in the web page data memory 44, the browser system 30 can judge whether some link data is designated at arbitrary positions in a displayed screen. The designation of link data is performed with moving an active cursor at arbitrary positions in the displayed screen by using the selection button 13. Of course, it is possible to store source data 66 for web pages in a memory for the data processing apparatus 100, such as a semiconductor memory or a magnetic disk apparatus, in order to shorten the access time for reproducing source data. Further, it is possible to store the source data in a memory of a relative small capacity by discarding the source data from a network with each access to a web page.

With reference to displaying contents on a screen, a registration operation of URL data will be explained. At an initial stage, a particular web page may be accessed by activating browser software to display a screen on the LCD display such as is, for example, shown in FIG. 5. The browser software 40 may download source data from a location indicated by a particular URL. The downloaded source data may be stored in the web page data memory 44. In accordance with the downloaded source data, the browser may display an address corresponding to the web page at address area 52. Further, web page data based on the source data may be displayed at page area 53.

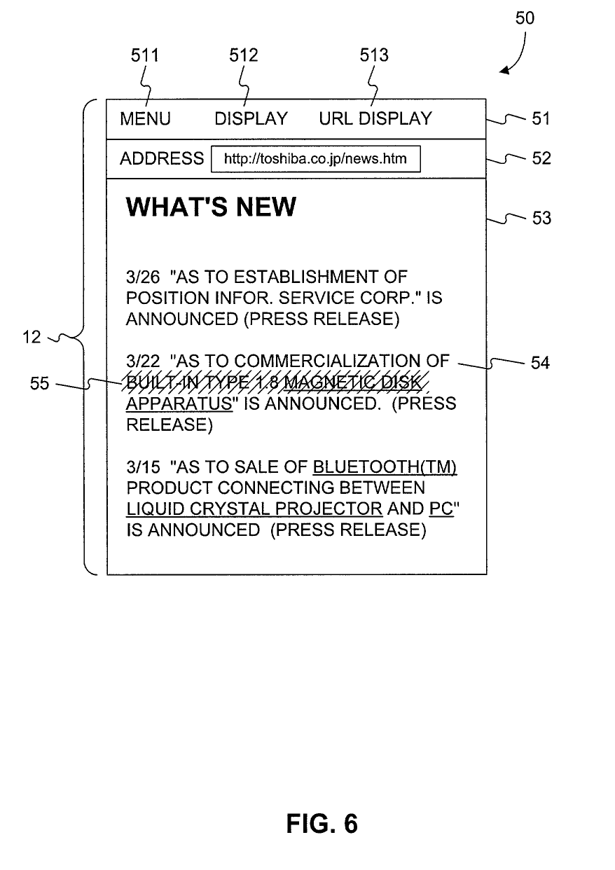

FIG. 6 illustrates an exemplary state where an active cursor is moved on a specified line of the web page of FIG. 5. Active cursor 55 may be moved up and down by operating selection button 13 in up and down directions in accordance with methods and systems consistent with the present invention. The active cursor 55 may be represented by highlighting one line in the page display area 53 such as, for example, by displaying a “netting” around the line. Of course, it is possible to indicate a character or a line in display area 53 by other techniques for character decoration over the “netting” for a one line range using the source data. For example, the credit display may be distinguished from other portions by displaying the character using a display mode having reversed foreground and background colors.

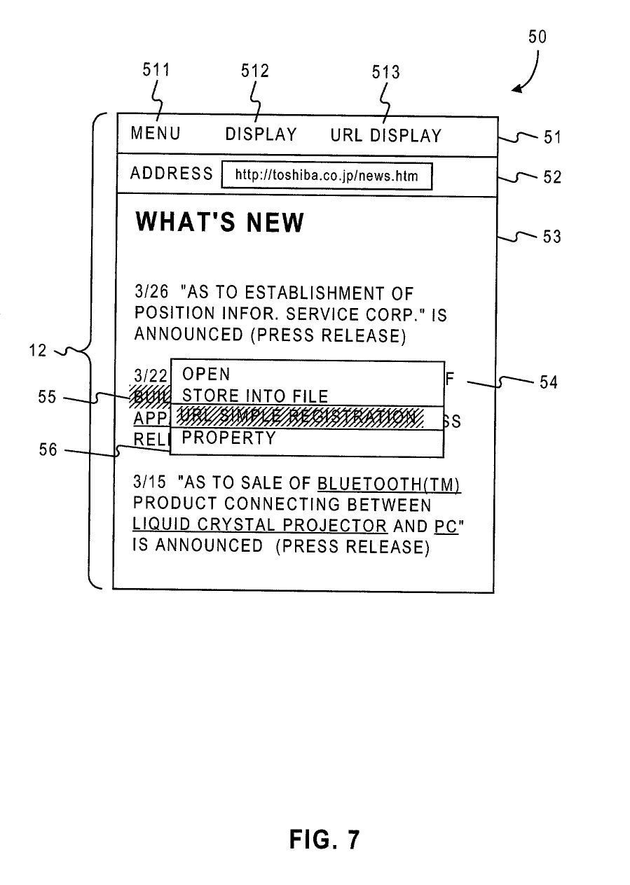

When the first function button 14 is pushed during the state when the active cursor 55 is displayed at a particular position in the page display area 53, a sub-menu screen 56 may be displayed around the active cursor 55 such as is illustrated, for example, in FIG. 7. In this state a user may select various kinds of menus displayed in the sub-menu screen 56 by moving menu selection cursor using the up and/or down button of selection button 13. For example, an easy URL registration menu in sub-menu screen 56 may be selected by moving the menu selection cursor to the sub-menu. In the sub-menu selection state, the sub-menu may be executed when the first function button 14 is also pushed. For example, the URL simple registration process may be executed to perform registration of URL data.

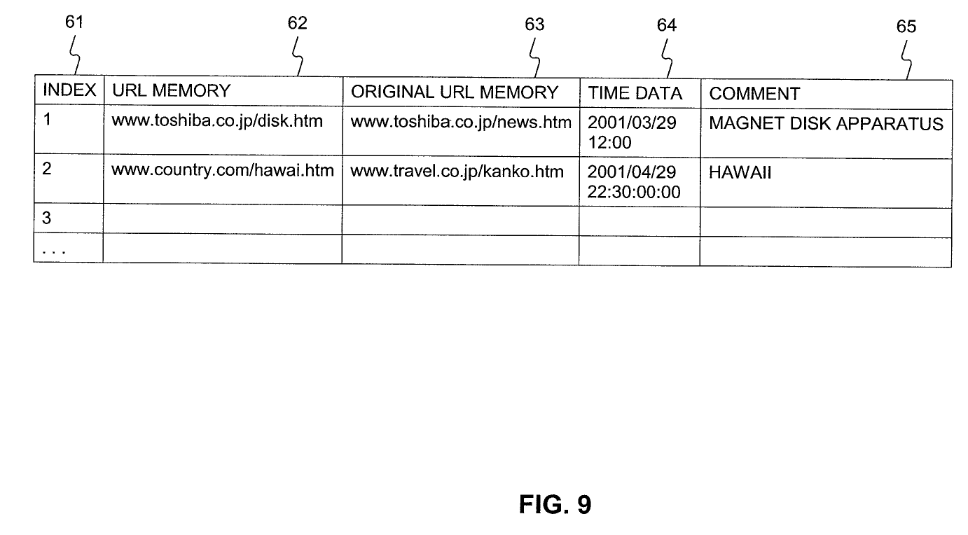

Easy URL registration may be performed by storing data into URL data memory 43 in a format such as is, for example, shown in FIG. 9. For example, URL data memory 43 may include an index memory area 61, a URL memory area 62, an original URL memory area 63, time data memory area 64, and comment memory area 65 to perform an easy URL registration. The first time the URL registration process is performed, the data may be stored at a first position indicated by index 61 position number 1 in the URL memory area 62. Thus, the URL data for the presently displayed web page may be stored in the original URL memory area 63. Further, based on the position of the active cursor, a corresponding URL data may be specified by the source data, and the specified URL data may be stored in URL memory area 62. Time and date information for the URL simple registration may be stored in the time data memory area 64. Further, the character sequence displayed in the web page to be registered as URL data, may be stored in comment memory area 65 as comment data. In the alternative, the comment data may be manually input. If a plurality of link data exists at the selected active cursor position, a user may elect to keep only desired URL data from the list of corresponding link data displayed on a screen.

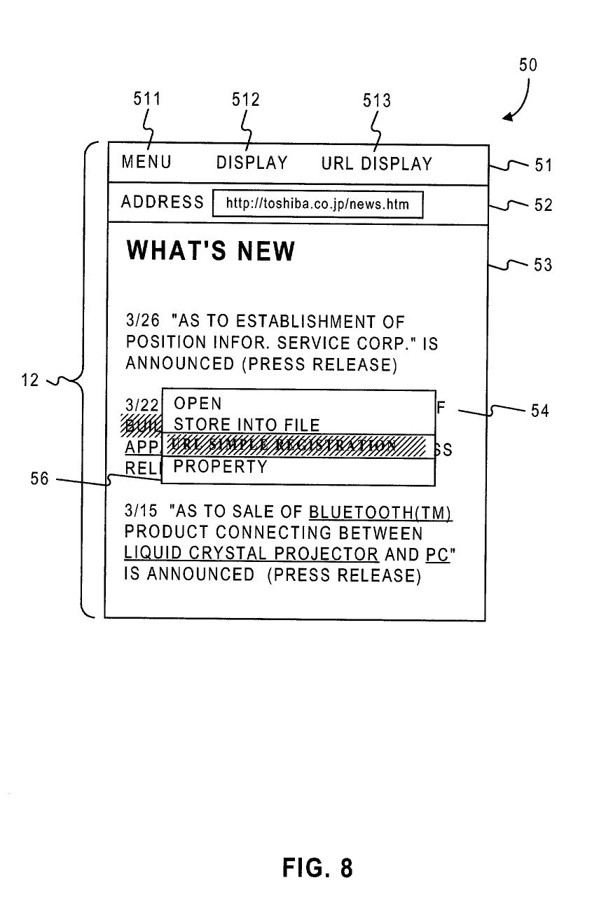

FIG. 8 shows an exemplary state where the sub-menu screen 56 may be opened by selecting function button 14 when the active cursor 55 is placed on a portion where link data has not been established. When link data has not been established in the source data at the position of the active cursor 55, menu selections of the URL simple registration for the sub-menu screen 56 may be displayed in gray. If a first function button 14 is operated in this state, the URL data registration process may not be performed.

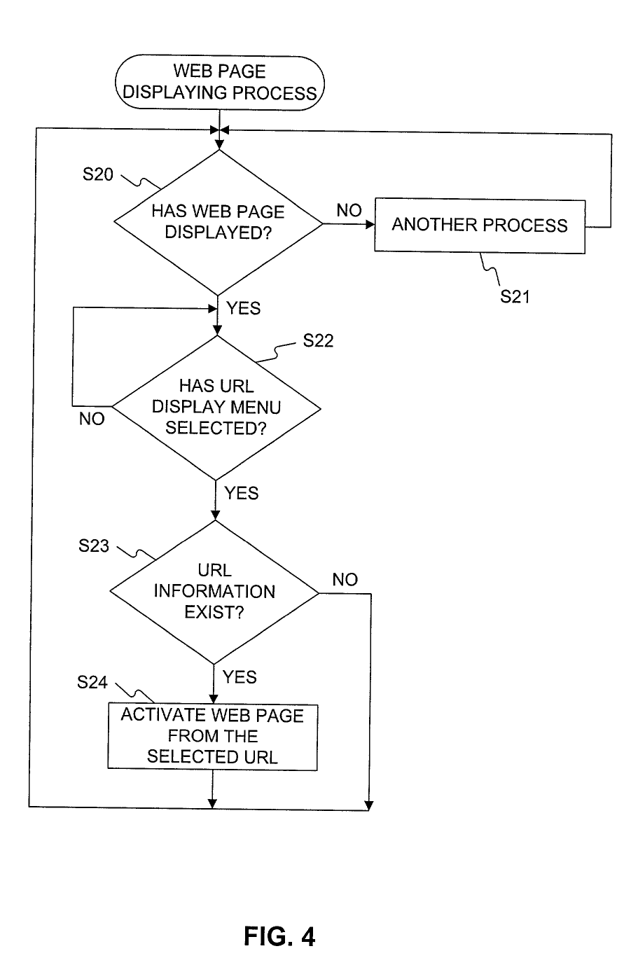

FIG. 4 is an exemplary flowchart showing a routine for displaying a web page based on registered URL data in accordance with methods and systems consistent with the present invention. First, browser system 40 in the data processing apparatus 100 may determine whether the web page has been displayed on the display/input unit (step S20). If the web page has not been displayed on the display/input unit (step S20, NO), then the browser system 40 may perform another process (step S21). If the web page has been displayed (step S20, YES), then the process may determine whether a URL display menu has been selected from menu display area 51 such as, for example, in the display shown in FIG. 5 (step S22). This process may be repeated until URL display menu 513 is selected. When the URL display menu 513 is selected, the process may determine whether the URL data is stored in URL data memory 43 (step S23). If the URL data is not registered, then the process may go to step S20. If the URL data is registered, the process may go to step S24. Thus, if the URL data is registered, the list of the registered URL data may be displayed in order to select some URL data using selection button 13. Source data for the web page may be downloaded through a network based on the selected URL data and the web page may be displayed (step S24).

If the URL display menu has not been selected (step S22, NO), then the process may go back without performing any particular operation. If the URL display menu has been selected (step S22, YES), then the process may determine whether any URL data exist in the web page (step S23). If there is no URL data (step S23, NO), then the process may go back to step S20. If any URL data exist (step S23, YES), the web page may be activated and displayed using the selected URL data (step S24).

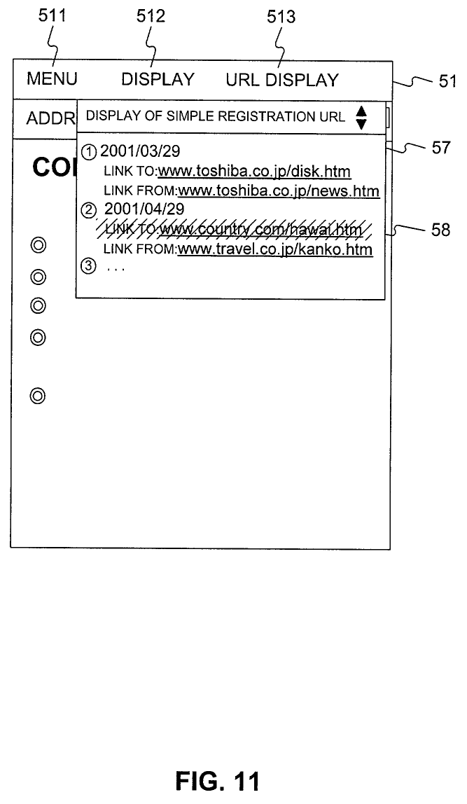

FIG. 11 illustrates an exemplary state in which a simple registration URL menu may be displayed on a web page in accordance with methods and systems consistent with the present invention. When URL display menu 513 is selected in the menu area 51 of the web page 50, a list screen 57 for the registered URL data may be displayed near URL display menu 513. URL data list screen 57 may be displayed using based on the data stored in the URL data memory 33. For example, URL data list screen 57, the URL data of link point receiver stored in the URL memory area 62, and URL data of link point sender stored in original URL memory area 63 may be displayed with the corresponding stored date in the order in which they were stored. URL data list screen 57 may be used to select desired link data by using the up and/or down buttons of selection button 13. In this embodiment, the selected link data may be shown in a net covering. When the selection cursor is displayed on a desired link data, the first function button 14 may be operated to select URL data corresponding to the selection cursor from the URL data memory 33. Based on the acquired URL data, a corresponding web page may be displayed. When there are too many registered URL data to display at once, the display may be scrolled with selection button 13.

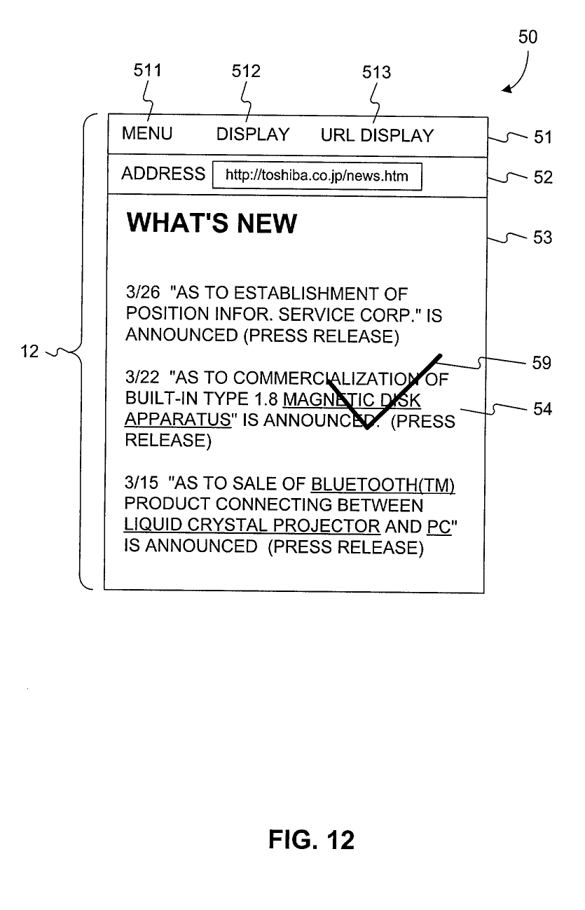

In the above-mentioned exemplary embodiments, URL data may be registered using selection button 13 to select a desired position in a web page with. Additionally, registration of URL data may be performed by other methods. For example, FIG. 12 illustrates an exemplary state in which an input gesture may be used to register a URL by selecting a desired portion using input pen 30 in accordance with methods and systems consistent with the present invention. Thus, the URL data registration process may be executed using a so-called gesture function. The gesture function may perform a particular process by recognizing an inputted pen form by comparing it to previously registered pen forms. In FIG. 12, the page display screen 53 includes an exemplary gesture 59 which may be used to represent URL simple registration. Thus, a user may input the gesture 59 using the input pen 30. When using the input pen 30, it may be difficult to select desired character sequences, since the page display area 53 of the display/input unit 12 may be relatively small. Using the gesture function, URL data may be registered by selecting desired URL data, even if the inputted pen form straddles across a plurality of lines.

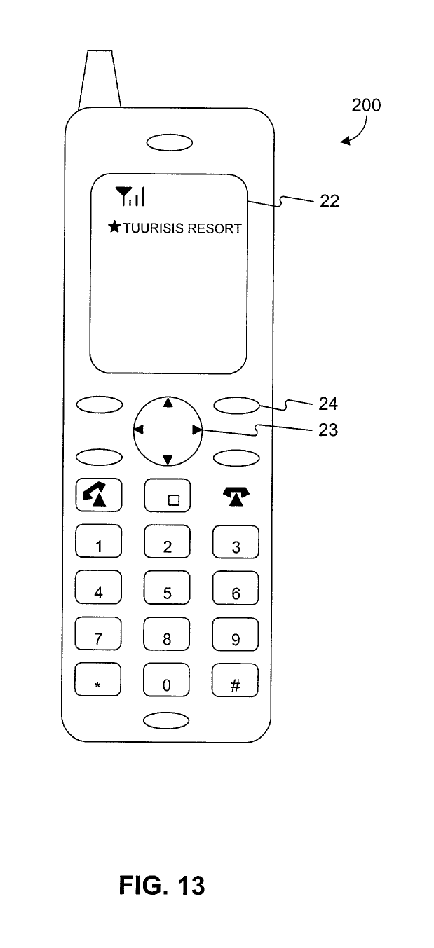

The URL data registration process consistent with the invention may be applied to a cellular telephone having a small display area. Thus, a mobile telephone may be used as another exemplary embodiment of a data processing apparatus in accordance with methods and systems consistent with the present invention. As illustrated in FIG. 13, a display area 22 for a mobile phone 200 may display approximately 100 characters. Moreover, various data selections may be performed using selection button 23. A function button 24 may be used to perform URL data registration.

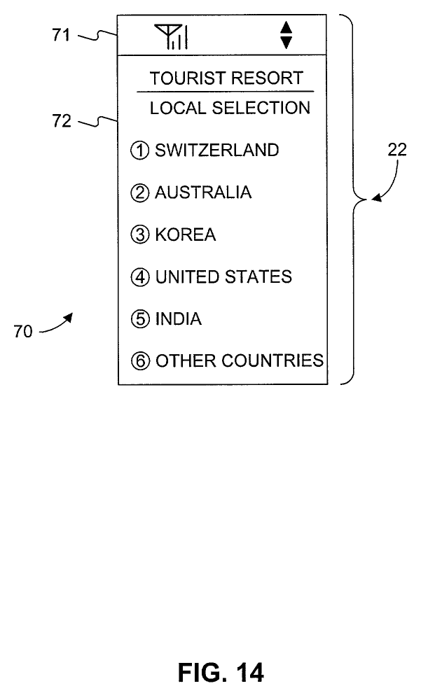

FIG. 14 illustrates another exemplary data processing apparatus in which data 70 such as, for example, a web page may be displayed in the display screen 22 of the cellular telephone of FIG. 13 in accordance with methods and systems consistent with the present invention. The display data 70 may include a system display area 71, and a page display area 72. The system display area 71 may indicate communication status. The page display area 72 may represent a web page. If the display data 70 is not displayed in a visible range of display screen 22, the remaining data may be displayed by scrolling up and down with the selection button 23. Thus, each of the contents currently displayed in the screen 22 may be matched to respective link data.

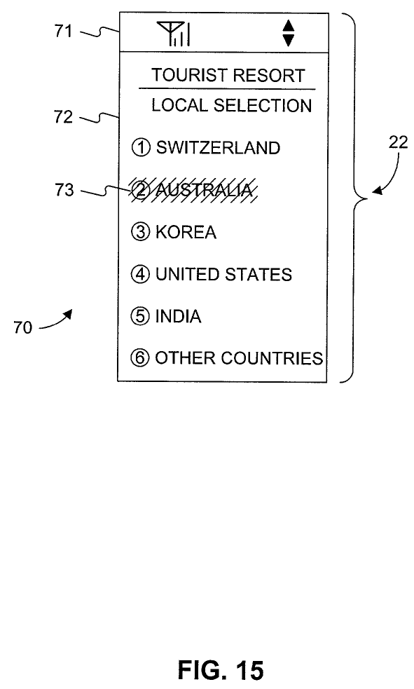

As illustrated in FIG. 15, a selection cursor 73 may be positioned on a specific desired choice 73 by moving up and down with selection button 13. Further, function button 24 may be operated to perform a specific URL data registration and the URL data corresponding to the selection may be stored in URL data memory.

As explained above, according to the invention, a user can select desired URL data displaying portion by using a selection button when a web page is displayed on a screen. Moreover, operation of a function button may perform a simple URL data registration by registering both URL data of the web page and URL data of link point.

The above embodiments and other aspects and principles of the present invention may be implemented in various environments. Such environments and related applications may be specially constructed for performing the various processes and operations of the invention or they may include a general-purpose computer or computing platform selectively activated or reconfigured by program code to provide the necessary functionality. The processes disclosed herein are not inherently related to any particular computer or other apparatus, and may be implemented by a suitable combination of hardware, software and/or firmware. For example, various general-purpose machines may be used with programs written in accordance with teachings of the present invention, or it may be more convenient to construct a specialized apparatus or system to perform the required methods and techniques.

The present invention also relates to computer readable media that include program instructions or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include micro-code, machine code, such as produced by a compiler, and files containing a high-level code that can be executed by the computer using an interpreter.

Other embodiments of the present invention will be apparent to those skilled in the art from consideration of the specification and practice of the invention disclosed herein. It is intended that the specification and examples be considered as exemplary only, with a true scope and sprit of the invention being indicated by the following claims.

What is claimed is:

1. A data processing apparatus, comprising:
a communication controller configured to communicate using a network;
a web page data memory configured to store web page data downloaded from the network using the communication controller;
a web page display configured to display at least one web page based on the web page data stored in the web page data memory;
an indicator configured to specify an indicated portion of the web page displayed on the web page display; and
an address data memory configured to store address data associated with the web page data.

2. The data processing apparatus according to claim 1, further comprising:
a selector configured to select a particular address data from the address data stored in the address data memory; and
a uniform resource locator display configured to display the web pages downloaded using the communication controller based on the selected address data.

3. The data processing apparatus according to claim 1, wherein:
the address data memory stores address data included in the indicated portion and address data in the presently displayed web page.

4. A data processing apparatus, comprising:
a web page data memory for storing web pages;
a web page display for displaying a web page based on web page data stored in the web page data memory;
a selector configured to select a specified portion on the web page displayed on the web display; and
an address data memory configured to store address data included in the web page data in accordance with the indicated portion by the selector.

5. A data processing apparatus, comprising:
a web page data memory configured to store web pages;
a web page display screen configured to display a web page based on web page data stored in the web page data memory;
a cursor button configured to move a line cursor displayed on the display screen;
a registration instructing button configured to register address data included in the displayed web page;
a unit configured to acquire address data associated with the web page data at a position pointed by the cursor button, when the registration instructing button is operated; and
an address data memory configured to store the acquired address data.

6. The data processing apparatus, according to claim 5, further comprising:
an instruction unit configured to store address data in the address memory, if the address data is included in the web page data at a position of the cursor button when a registration is instructed by the registration instructing button, and to display a notice that the address data cannot be stored, if the address data is not included in the web page data at a position of the cursor button when a registration is instructed by the registration instructing button.

7. The data processing apparatus, according to claim 5, further comprising:
a communication controller configured to communicate on a network, wherein the web page data memory stores the web page data downloaded by the communication controller from the network.

8. The data processing apparatus, according to claim 7, further comprising:
a selector configured to select a particular address data from the address data stored in the address data memory; and
a URL display configured to display a web page downloaded using the communication controller based on the selected address data.

9. The data processing apparatus, according to claim 5, wherein:
the address data memory stores an address data included in the selected portion and address data included in the presently displayed web page.

10. A method for processing data, comprising:
downloading data of a web page on a network by wireless communication;
storing the downloaded web page data in a web page data memory;
displaying the web page based on the stored web page data in the web page data memory;
indicating a specified portion on the web page displayed on the display web page; and
storing address data included in the indicated specified portion of the web page as a registration data.

11. The method for processing data according to claim 10, further comprising:
selecting a particular address data from the stored address data;
downloading web page data through a network based on the selected particular address data; and
displaying a web page on a screen based on the downloaded web page data.

12. The method for processing data according to claim 10, further comprising:
storing both address data included in the indicated particular portion and address data on the displayed web page, as registration data.

13. The method for processing data according to claim 10, further comprising:
indicating address data included in web page data on the displayed screen;
acquiring address data included in the web page data corresponding to a position of an active cursor in the displayed web page; and
storing the address data as registration data.

14. A computer program product, comprising a computer readable medium having computer program code embodied in said medium, wherein said program code comprises:
code for controlling communication using a network;
code for storing web page data downloaded from the network in a web page memory;
code for displaying a web page according to the web page data stored in the web page memory;
code for specifying an indicated portion of the web page displayed on the web page display; and
code for storing address data associated with the web page data in an address memory.
